(19) United States
(12) Patent Application Publication
(10) Pub. No.: US 2023/0058763 A1
(43) Pub. Date: Feb. 23, 2023

(54) COLORED DIRECT LASER MARKING ON TIRE

(71) Applicant: PANASONIC CORPORATION OF NORTH AMERICA, Newark, NJ (US)

(72) Inventor: JAMES HENRY ZDUNIC, III, FLORENCE, KY (US)

(73) Assignee: Panasonic Corporation, (omitted)

(21) Appl. No.: 17/405,731

(22) Filed: Aug. 18, 2021

(51) Int. Cl. B60C 13/00; B60C 13/04; B23K 26/364; B23K 26/402

(52) U.S. Cl. CPC B60C 13/001; B23K 26/364; B23K 26/402; B60C 13/04; B23K 2103/172; B60C 2013/045

(57) ABSTRACT

A motor vehicle tire includes a sidewall having an inner layer of a first color and an outer layer adjacent the inner layer. The outer layer is of a second color different from the first color. The outer layer has a plurality of throughholes that visually expose the inner layer. The throughholes are in a pattern that encodes information about a history of the motor vehicle tire and/or a unique identifier

### BACKGROUND OF THE INVENTION

### 1. Field of the Invention

The present invention relates to a motor vehicle tire marking system.

### 2. Description of the Related Art

There is a need to maintain and quickly access data associated with a motor vehicle tire, such as its date(s) and location(s) of manufacture, date and location of sale, date and location of installation on a vehicle, VIN information of the vehicle installed on, etc. A problem is that such data cannot be permanently recorded on a tire such that the data is visible and quickly accessed. A tire is often operated in a dirty, wet environment, and it is subject to high levels of force and wear. Any data recorded on a tire can be eventually obscured or obliterated.

In a known tire marking method, a laser is used to etch away material from the surface layer of a sidewall of the tire to thereby create a mark thereon. Because the mark and the surrounding background surface are the same color (e.g., black), the mark can only be seen from the shadows created by light that illuminates the sidewall from a direction substantially parallel to the tire surface that has been etched. However, such markings can be very difficult to see by humans or machines because of low contrast requiring the lighting conditions to be just right.

### SUMMARY OF THE INVENTION

The present invention may include using laser energy to remove layer(s) of material(s) on the surface of a tire, thereby exposing different colored sub layer(s) of material(s) on the tire. The different colored sub layer(s) of material(s) may be exposed in such a way as to encode data about the history of the tire and/or a unique identifier for the tire. Thus, the invention may include use of a laser to remove top surface layer(s) exposing colored sub-layer(s) to create a mark that is a different color than the outermost surface layer(s) of the tire.

The invention may enable direct multicolored marking of information onto rubber tires. The mark(s) may have a different color(s) than the outermost surface on which the marks are made. The marks may be produced using only laser energy, without the need to attach a label, ink, or other material on the tire, or to use other tools to expose the colored sub layers.

The invention comprises, in one form thereof, a motor vehicle tire including a sidewall having an inner layer of a first color and an outer layer parallel to and adjacent the inner layer. The outer layer is of a second color different from the first color. The outer layer has a plurality of throughholes that visually expose the inner layer(s). The throughholes are in a pattern that encodes information about a history and/or a unique identifier of the motor vehicle tire.

The invention comprises, in another form thereof, a method of recording information on a motor vehicle tire, including providing a sidewall of the tire with an inner layer(s) that is of a first color(s). The sidewall of the tire is provided with an outer layer(s) adjacent and parallel to the inner layer(s). The outermost layer is of a second color that is different from the first color(s). The outer layer is nonresistant to laser etching. The application of the laser energy is controlled such that the depth of material removal is controlled to expose the desired inner layer(s).

The invention comprises, in yet another form thereof, a method of recording information on a motor vehicle tire, including laser etching an outer layer of a sidewall of the tire to visually expose an inner layer(s) of the sidewall. The outer layer being of a first color, the inner layer(s) being of a second color(s) that are different than the first color, the outer layer being laser etched in a pattern to encode information about previous events associated with the tire. The encoded information may include a unique identifier which can be seen by humans and/or machines and recorded during manufacturing processes, sale, installation, and tied to the VIN number of the vehicle it is installed on for traceability reasons.

Although the tire material may be removed by grinding, milling, or drilling instead of laser energy, these methods do not provide the positional accuracy, mark content variability, mark consistency, and process repeatability/reliability of laser processes.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a plan view of a motor vehicle tire including one embodiment of a marking of the present invention.

FIG. 2 is a side view along line 2—2 of FIG. 1 of the marking and a laser that etched the marking.

FIG. 3 is a flow chart of one embodiment of a method of the present invention for recording information on a motor vehicle tire.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

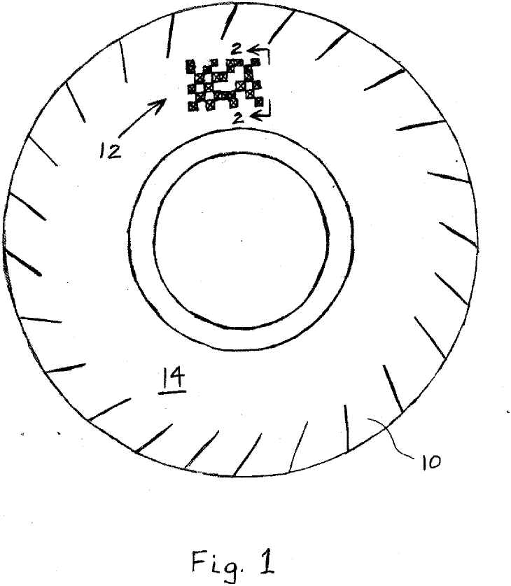

FIG. 1 illustrates a motor vehicle tire 10 including a marking 12 of the present invention on a sidewall 14 of tire 10. In the particular embodiment shown, marking 12 includes a six row by nine column matrix of pixels, each pixel representing one binary bit of information. However, it is to be understood that the marking may be a matrix of any size (e.g., any number or rows and columns), and the size of the individual pixels may also vary within the scope of the invention.

Although the blank pixels of marking 12 and the remainder of sidewall 14 are shown as white in FIG. 1, it is to be understood that they may in actuality be black in color, or any other color other than the color of marking 12, and may be made of a rubber material. The pixels that are depicted in FIG. 1 with an “x” are in actuality some color other than black (e.g., yellow) and are made of a layer of colored material that is under the outer surface of black rubber. The pixels that are depicted with an “x” may be created by laser etching away the top layer of black rubber material to thereby visually expose the underlying layer of colored material.

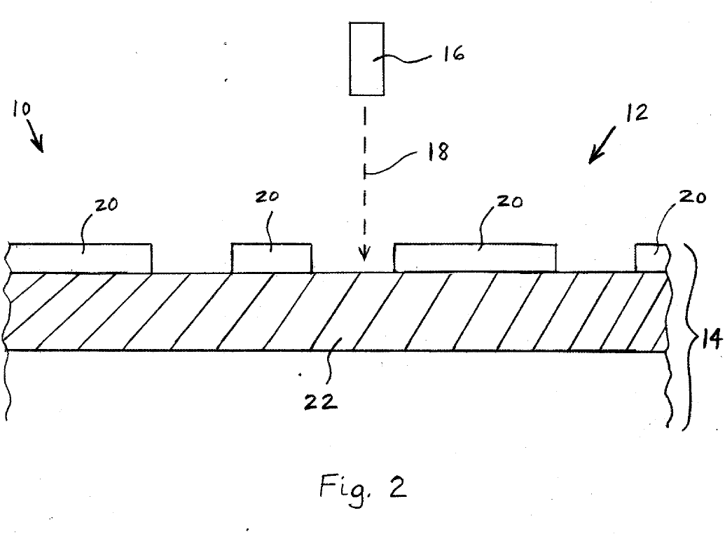

FIG. 2 illustrates marking 12 and a laser 16 that etched marking 12 by emitting laser energy 18. Laser energy 18 may etch away or otherwise remove top layer 20 of black rubber material to thereby visually expose the underlying layer 22 of colored material.

During use, a respective additional marking 12 may be made on tire 10 to provide information (e.g., date, location, number of miles, type of vehicle, etc.) about each significant event that occurs in the life of tire 10. Such significant events may include manufacture, sale, installation on a vehicle, removal from a vehicle, repair of the tire, treatments, etc.

Top layer 20 of black rubber material may have characteristics that make it etchable such that the material can be removed by laser etching. In contrast, underlying layer 22 of colored material may have characteristics that make it resistant to etching such that the material cannot be easily removed by laser etching. In another embodiment, the application of laser energy may be controlled to produce a desired depth of material removal that is just short of, and thereby exposes, a differently-colored inner layer that does not have characteristics that make it resistant to etching. Controlling the depth of material removal by adjusting the application of the laser energy enables selection from multiple internal colored layers, and provides the ability to produce multi-colored marks if desired.

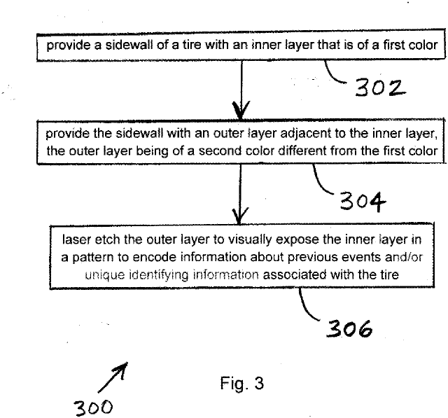

FIG. 3 illustrates one embodiment of a method 300 of the present invention for recording information on a motor vehicle tire. In a first step 302, a sidewall of the tire is provided with an inner layer that is of a first color. For example, sidewall 14 of tire 10 is provided with an inner layer 22 that may be some color other than black, such as white or yellow.

In a next step 304, the sidewall is provided with an outer layer adjacent to the inner layer. The outer layer is of a second color different from the first color. For example, sidewall 14 may be black in color.

In a final step 306, the outer layer is laser etched to visually expose the inner layer in a pattern to encode information about previous events associated with the tire. For example, outer layer 20 may be laser etched by laser 16 to visually expose inner layer 22 in a pattern as shown in marking 12 to encode information about previous events associated with the tire, such as where the tire was manufactured and/or a unique identifier.

Although markings of the present invention are shown herein as being applied to a tire, it is to be understood that the markings may be applied to a wide variety of products. Markings of the present invention (e.g., date codes/serial numbers), such as marking 12, may enable identification, tracing and tracking of the entire life cycle of a product/tire from materials used in manufacture, sale, installation, all the way through the chain of use to disposal.

Inner layer 22 has been described herein as being adjacent to outer layer 20. However, it is also possible within the scope of the invention for there to be one or more intermediary layers that are nonresistant to laser etching between the inner layer and the outer layer. The application of laser energy may be controlled to produce a desired depth of material removal with inner layers that do not have characteristics that make them resistant to etching.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. A motor vehicle tire including a sidewall, the sidewall comprising:
an inner layer having a first color; and
an outer layer parallel to the inner layer, the outer layer having a second color different from the first color, the outer layer having a plurality of throughholes that visually expose the inner layer, the throughholes being in a pattern that encodes information about a history of the motor vehicle tire and/or information identifying the motor vehicle tire.

2. The motor vehicle of claim 1 wherein the first color is a color other than black, and the second color is black.

3. The motor vehicle of claim 1 wherein the outer layer is adjacent the inner layer and is made of rubber.

4. The motor vehicle of claim 1 wherein the pattern of throughholes is in a matrix of rows and columns.

5. The motor vehicle of claim 1 wherein the pattern encodes information about a location and date that the tire was manufactured.

6. The motor vehicle of claim 1 wherein the inner layer is made of a material that is resistant to laser etching.

7. The motor vehicle of claim 6 wherein the outer layer is made of a material that is nonresistant to laser etching.

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. A motor vehicle tire including a sidewall, the sidewall comprising:
an inner layer having a first color; and
an outer layer having a second color different from the first color, the outer layer having a plurality of throughholes that visually expose the inner layer, the throughholes being in a pattern that encodes information about a history of the motor vehicle tire and/or information identifying the motor vehicle tire.

22. The motor vehicle of claim 21 wherein the first color is a color other than black, and the second color is black.

23. The motor vehicle of claim 21 wherein the outer layer is adjacent the inner layer and is made of rubber.

24. The motor vehicle of claim 21 wherein the pattern of throughholes is in a matrix of rows and columns.

25. The motor vehicle of claim 21 wherein the pattern encodes information about a location and date that the tire was manufactured.

26. The motor vehicle of claim 21 wherein the inner layer is made of a material that is resistant to laser etching.

27. The motor vehicle of claim 26 wherein the outer layer is made of a material that is nonresistant to laser etching.

28. A motor vehicle tire including a sidewall, the sidewall comprising:
an inner layer having a first color; and
an outer layer parallel to the inner layer, the outer layer having a second color different from the first color, the outer layer having a plurality of throughholes that visually expose the inner layer, the throughholes having at least one characteristic that encodes information about a history of the motor vehicle tire and/or information identifying the motor vehicle tire.

29. The motor vehicle of claim 28 wherein the first color is a color other than black, and the second color is black.

30. The motor vehicle of claim 28 wherein the outer layer is adjacent the inner layer and is made of rubber.

31. The motor vehicle of claim 28 wherein the throughholes are arranged in a matrix of rows and columns.

32. The motor vehicle of claim 28 wherein the characteristic of the throughholes encodes information about a location and date that the tire was manufactured.

33. The motor vehicle of claim 28 wherein the inner layer is made of a material that is resistant to laser etching, and the outer layer is made of a material that is nonresistant to laser etching.
